(19) United States
(12) Patent Application Publication
(10) Pub. No.: US 2023/0097788 A1
(43) Pub. Date: Mar. 30, 2023

(54) MOLDING APPARATUS AND MOLDING METHOD FOR PRECISION GLASS ELEMENTS

(71) Applicant: Moore Nanotechnology Systems, LLC, Swanzey, NH (US)

(72) Inventors: Christopher J. Morgan, Keene, NH (US); Mark S. Johannesson, Peterborough, NH (US); Michael R. Brochu, Swanzey, NH (US)

(73) Assignee: Moore Nanotechnology Systems, LLC, Swanzey, NH (US)

(21) Appl. No.: 17/954,692

(22) Filed: Sep. 28, 2022

Related U.S. Application Data
(60) Provisional application No. 63/249,298, filed on Sep. 28, 2021.

(51) Int. Cl. C03B 11/08; C03B 11/12

(52) U.S. Cl. CPC C03B 11/08; C03B 11/122; C03B 11/125; C03B 2215/66; C03B 2215/50

(57) ABSTRACT

According to one example, a molding apparatus may be utilized to mold one or more glass elements by heating of one or more glass materials and pressing the one or more glass materials between an upper mold and a lower mold. The molding apparatus includes a radiant heating module comprising a plurality of radiant heating elements, an upper resistive heating module comprising a first plurality of independently controlled resistive heating elements, and a lower resistive heating module comprising a second plurality of independently controlled resistive heating elements.

### CROSS-REFERENCE TO RELATED APPLICATIONS

This application claims priority to U.S. Provisional Patent Application No. 63/249,298 entitled “Molding Apparatus and Molding Method for Precision Glass Elements” and filed Sep. 28, 2021, the entirety of which is incorporated herein by reference.

### TECHNICAL FIELD

This disclosure relates generally to glass molding, and more particularly to a molding apparatus and molding method for precision glass elements.

### BACKGROUND

Conventionally, molding of precision glass elements is performed by heating a glass material above the softening point and pressing the glass material between an upper mold and a lower mold to form a precision glass element. Typical examples of such a molding apparatus and molding method are described in Japan Patent No. JP3832986B2; U.S. Pat. No. 4,734,118; Japan Patent No. JP6540684B2; and U.S. Pat. No. 6,184,498, each of which is incorporated herein by reference in its entirety. These typical molding apparatuses and methods, however, may be deficient.

### SUMMARY

According to one example, a molding apparatus may be utilized to mold one or more glass elements by heating of one or more glass materials and pressing the one or more glass materials between an upper mold and a lower mold. The molding apparatus includes a radiant heating module comprising a plurality of radiant heating elements, an upper resistive heating module comprising a first plurality of independently controlled resistive heating elements, and a lower resistive heating module comprising a second plurality of independently controlled resistive heating elements.

According to another example, a molding method for molding one or more glass elements includes utilizing each of a radiant heating module comprising a plurality of radiant heating elements, an upper resistive heating module comprising a first plurality of independently controlled resistive heating elements, and a lower resistive heating module comprising a second plurality of independently controlled resistive heating elements, to heat one or more glass materials. The molding method further includes pressing the one or more glass materials between an upper mold and a lower mold.

According to a further example, a molding apparatus and molding method may be utilized for molding precision glass elements by heating of a glass material, or materials, and pressing the glass material, or materials, between an upper mold comprising a single or plurality of molds, and a lower mold comprising a single or plurality of molds to form a glass element or elements. In the molding apparatus and molding method, heating is achieved by a radiant heating module comprising a plurality of radiant heating elements, an upper resistive heating module comprising a plurality of resistive heating elements, and a lower resistive heating module comprising a plurality of resistive heating elements. The combination of heating elements increases the heating rate of the molding method, in some examples. The resistive heating elements and the radiant heating elements are controlled independently to obtain a desired temperature gradient of the glass element or elements, in some examples.

According to another example, a molding apparatus and molding method may be utilized for molding precision glass elements by heating of a glass material, or materials, and pressing the glass material, or materials, between an upper mold comprising a single or plurality of molds, and a lower mold comprising a single or plurality of molds to form a glass element or elements. In the molding apparatus and molding method, the cooling of the glass (or other optical material) is achieved by a flow of inert gas, an upper resistive heating module comprising a plurality of resistive heating elements, and a lower resistive heating module comprising a plurality of multiple resistive heating elements. The combination of inert gas flow and resistive heating elements controls the cooling rate of the glass element, in some examples.

According to another example, a molding apparatus and molding method may be utilized for molding precision glass elements by heating of a glass material, or materials, and pressing the glass material, or materials, between an upper mold comprising a single or plurality of molds, and a lower mold comprising a single or plurality of molds to form a glass element or elements. In the molding apparatus and molding method, the temperature is measured by a temperature monitoring device comprising an infrared camera. The infrared camera assists in determining the softening point of the glass material, in some examples.

According to another example, a molding apparatus and molding method may be utilized for molding precision glass elements by heating of a glass material, or materials, and pressing the glass material, or materials, between an upper mold comprising a single or plurality of molds, and a lower mold comprising a single or plurality of molds to form a glass element or elements. In the molding apparatus and molding method, the upper and lower molds are aligned by guide pins, where the guide pins are connected to a positioning device so the surface of a guide pin is co-planar with the surface of the mold during heating, and then extended from the mold during pressing so the guide pin can be utilized to align holes in the top mold with holes in the bottom mold.

According to another example, a molding apparatus and molding method may be utilized for molding precision glass elements by heating of a glass material, or materials, in a processing chamber and pressing the glass material, or materials, between an upper mold comprising a single or plurality of molds, and a lower mold comprising a single or plurality of molds to form a glass element or elements. In the molding apparatus and molding method, heating is achieved by a radiant heating module mounted in the processing chamber comprising a plurality of radiant heating elements, the radiant heating module being capable of mounting and un-mounting from the processing chamber in a way to maintain the plurality of radiant heating elements in the radiant heating module.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a plot of the glass element molding cycle in four steps: (1) heating, (2) pressing, (3) gradual cooling, and (4) rapid cooling.

FIG. 2 illustrates an example molding apparatus for molding precision glass elements by heating with a combination of a radiant heating module, an upper resistive heating module, and a lower resistive heating module.

FIG. 3 illustrates an example radiant heating module of the molding apparatus of FIG. 2, where the radiant heating module can be removed from the heating chamber as a singular item.

FIG. 4 illustrates an example resistive heating module of the molding apparatus of FIG. 2, where the resistive heating module includes three resistive heating elements which can each be independently controlled.

FIG. 5 illustrates an example of molds, radiant heating elements, resistive heating elements, an infrared camera device, and other components that may be utilized in the molding apparatus of FIG. 2, where the top and bottom molds each include multiple mold pins arranged in a mold plate, and the glass material is a plurality of spheres.

FIG. 6 illustrates another example of molds, radiant heating elements, resistive heating elements, and other components that may be utilized in the molding apparatus of FIG. 2, where the top and bottom molds are each a singular monolithic piece of material, and the glass material is a plurality of spheres.

FIG. 7 illustrates a further example of molds, radiant heating elements, resistive heating elements, and other components that may be utilized in the molding apparatus of FIG. 2, where the top and bottom molds are each a singular monolithic piece of material, and the glass material is a singular disk, or wafer.

FIG. 8A illustrates an example of molds, glass elements, and guide pins that may be utilized in the molding apparatus of FIG. 2, where the guide pins are in a retracted position for heating.

FIG. 8B illustrates an example of molds, glass elements, and guide pins that may be utilized in the molding apparatus of FIG. 2, where the guide pins are extended to align the top and bottom molds.

### DETAILED DESCRIPTION

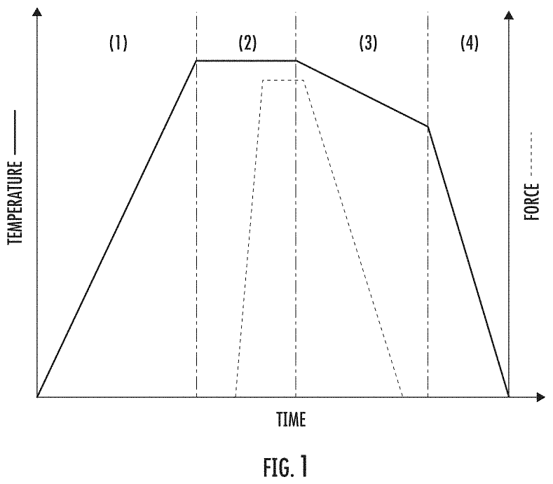

Examples of the present disclosure are best understood by referring to FIGS. 1-8 of the drawings, like numerals being used for like and corresponding parts of the various drawings.

Molding of precision glass elements is typically achieved by the steps plotted in FIG. 1. As is illustrated in FIG. 1, the glass material is first placed in a processing chamber and heated above the softening point. Next, the glass material is pressed between an upper mold and a lower mold such that a glass element is formed, such as a glass lens. The glass element is then gradually cooled, or annealed, below the softening point. Finally, the glass element is rapidly cooled to a lower temperature for removal from the processing chamber.

It is desirable to minimize the time for the molding process to improve throughput, in some examples. One typical example for achieving this involves increasing the heating power to reduce the time required to heat the glass material. But short heating times can create temperature gradients in the glass material. This may result in localized melting or cracking, which can create defects in the glass element. Another typical example for minimizing the time for the molding process involves minimizing the time for gradual cooling of the glass material. However, fast gradual cooling may create residual stress in the glass element which is not desirable in some applications, such as lenses.

Additionally, typical molding apparatuses utilize only radiant heating elements and therefore heating power is limited and temperature gradients are difficult to control based on reflections of the light. In one example, radiant and resistive heating elements are utilized, however, the heating is achieved by a radiant heating module, one upper resistive heating element, and one lower resistive heating element. As such, temperature gradients in the glass material cannot be controlled.

In contrast to this, the molding apparatuses and molding methods discussed herein may address one or more of these deficiencies. For example, the molding apparatuses and molding methods herein may precisely control the rate of gradual cooling (and/or heating). This may minimize residual stress, may eliminate the need to further anneal the glass element, and may improve the precision.

According to one example, a molding apparatus for precision glass elements includes a radiant heating module, an upper resistive heating module in contact with an upper mold, and a lower resistive heating module in contact with the lower mold, wherein each heating module contains multiple heating elements for independent power control. The sum of the modules increases the heating power of the mold apparatus, while independent control of the heating elements reduces the temperature gradient of the glass material, in some examples. Also, the resistive heating elements may be utilized to control the gradient of the glass material during gradual cooling. This is achieved by a combination of (1) cooling with a flow of an inert gas and (2) heating with resistive heating elements. This achieves shorter heating times while precisely controlling the gradual cooling rate, in some examples.

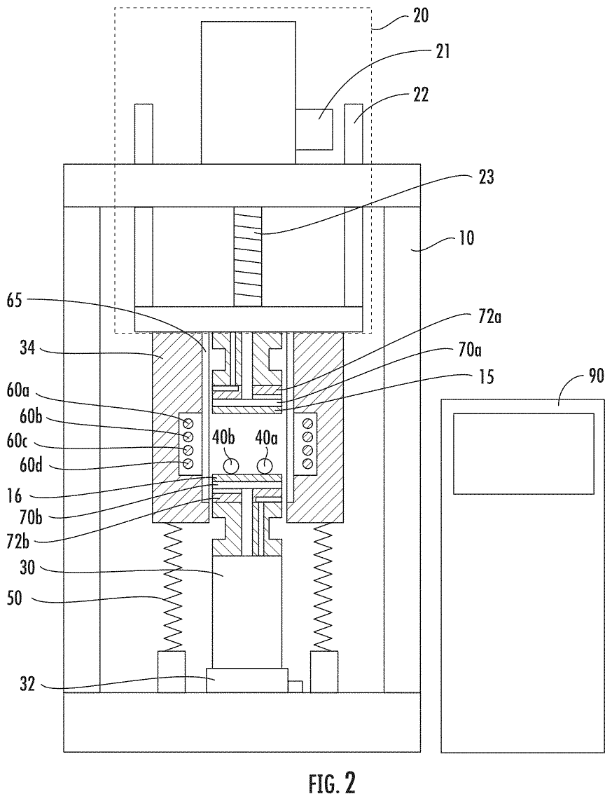

FIG. 2 illustrates an example of a molding apparatus 1 that may be utilized for molding of precision glass elements. In the example illustrated in FIG. 2, the apparatus 1 has an overall frame 10 that encompasses the entire system. The top mold 15 and bottom mold 16 are displaced relative to one another by a servo motor 21, bearing mechanism 22, jack screw 23, and position feedback device (all of which are referred to as ram 20). The jack screw 23 has sufficient capacity to also press the glass material 40 (e.g., 40a, 40b) with high force. The anvil 30 mounts to a load detection device 32 for monitoring the force applied to the glass material 40 by the ram 20. The processing chamber 34 is sealed in a way to permit a vacuum or inert gas environment during molding. A flexible bellows 50 is utilized to achieve sealing with motion, but any method for sealing may be used. For instance, a sliding mechanical seal may be sufficient, in some examples.

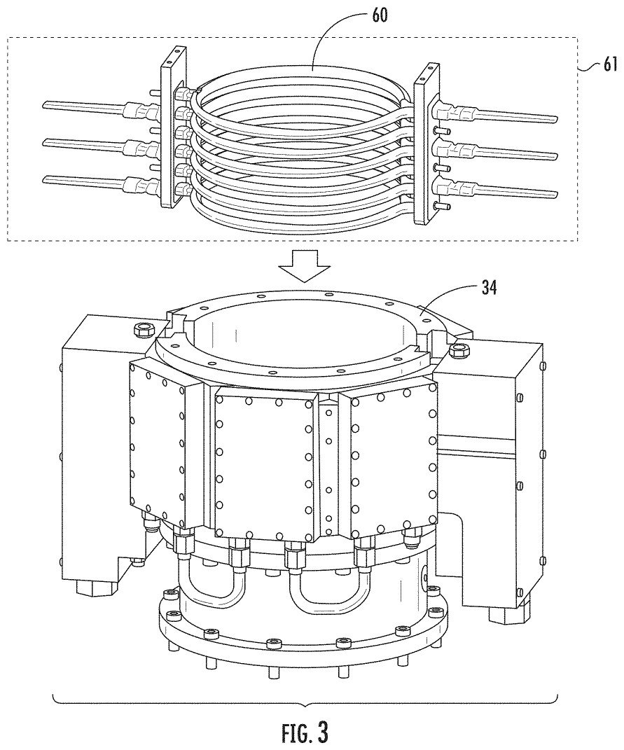

The processing chamber 34 includes one or more radiant heating elements 60 for heating the glass material 40 and molds 15 and 16. The example in FIG. 2 illustrates four radiant heating elements 60 (e.g., 60a-60b), but any number of radiant heating elements 60 may be used. The radiant heating elements 60 may be infrared heating lamps, in some examples, but any other type of radiant heating elements 60 may be used. In the illustrated example, the radiant heating elements 60 are outside the sealed volume of the processing chamber 34 and separated from the sealed volume by a transparent quartz tube 65. In other examples, the processing chamber 34 may not include a transparent quartz tube 65. The radiant heating elements 60 may be consumed over time, due to degradation of the filament utilized in infrared heating lamps. The filament is made of tungsten, in some examples. In some examples, the radiant heating elements 60 may all be removable as a singular unit, so as to minimize the time required to replace the radiant heating elements 60. An example of such a singular unit is seen in FIG. 3, which illustrates an example of a radiant heating module 61. The radiant heating module 61 may be a removable singular unit that includes each of the radiant heating elements 60. The radiant heating elements 60 may remain mounted on the radiant heating module 61 during mounting and un-mounting (e.g., removal) of the radiant heating module 61 from the processing chamber 34.

In the example illustrated in FIG. 2, the glass material 40 includes two spherical glass materials 40a and 40b. However, any other number of glass materials 40 may be molded using the molding apparatus 1. Furthermore, the glass material 40 may have any size and/or shape that may be used for creating glass elements. The size and/or shape of the glass material 40 may influence the size and shape of the glass elements (or vice versa). The glass material 40 may be any moldable glass material, for example n-BK7. In the example illustrated in FIG. 2, the glass material 40 is placed on the bottom mold 16, and the top mold 15 is mounted to the ram 20. Between the top mold 15 and the ram 20, a resistive heating module 70a is mounted, as well as a cooling plate 72a that includes channels for inert gas flow. A resistive heating module 70b is mounted between the bottom mold 16 and the anvil 30, as well as a cooling plate 72b that includes channels for inert gas flow. A cooling plate 72 may include one or more channels. For example, the cooling plate 72 may include multiple channels. In some examples, the inert gas flow rate in each channel of the cooling plate 72 is controlled individually. A temperature monitoring device 65 may be utilized to monitor the temperature of the molds 15 and 16 and/or the glass material 40. The temperature monitoring device 65 may be any temperature monitoring device, such as a thermocouple, in some examples. The servo motor 21, position feedback device, load detection device 32, heating elements, inert gas flow, and temperature monitoring device 65 are connected to a controller 90 to achieve the desired temperature and force profile (see FIG. 1).

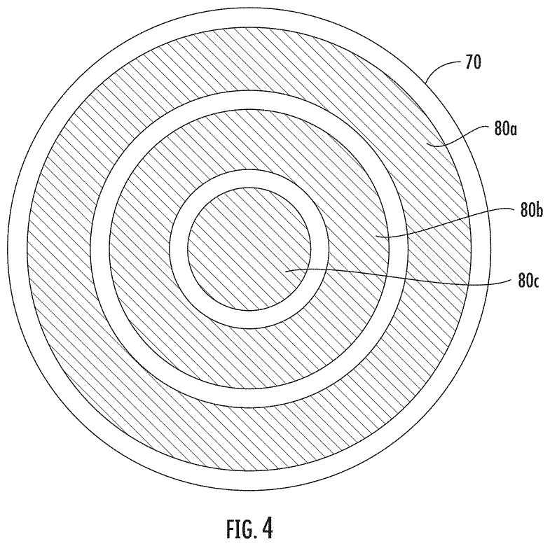

The resistive heating module 70 (e.g., 70a and/or 70b) may include one or more resistive heating elements 80 for controlling the temperature gradient of the glass material 40. In the example illustrated in FIG. 4, the resistive heating module 70 includes three resistive heating elements 80 (e.g., 80a, 80b, and 80c), but any number greater than one may be used to achieve independent control. In the illustrated example, the three resistive heating elements 80 creates three zones of heating: an outer zone created by resistive heating element 80a, a middle zone created by resistive heating element 80b, and an inner zone created by resistive heating element 80c. Each resistive element 80 (and therefore each zone) may be controlled independently, allowing each zone to be heated to a different temperature. This may allow the apparatus 1 to control (and sometimes eliminate) the temperature gradient of the glass material 40 during heating and/or cooling. A resistive heating element 80 may be utilized in any step of the molding process, including heating and cooling, in some examples. The resistive heating module 70 (e.g., 70a and/or 70b) may include tungsten filaments embedded in an aluminum nitride ceramic, in some examples.

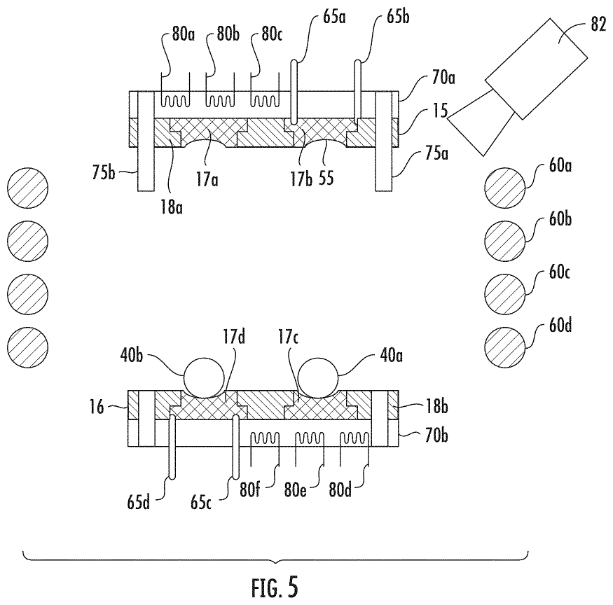

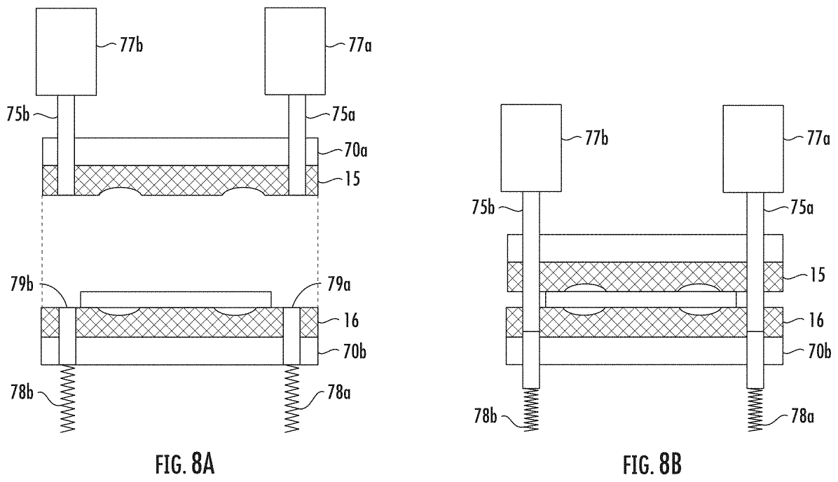

The molds 15 and 16 may each include a singular or plurality number of cavities 55 for molding a glass element or elements. FIG. 5 illustrates an example of a mold 15 and a mold 16 with two cavities 55 for molding two glass elements. The molds 15 and 16 may each be manufactured from any material, but are each typically made from a high-temperature compatible material like tungsten carbide or silicon carbide. The illustration in FIG. 5 shows two guide pins 75 (e.g., 75a and 75b) which can be used to align the top mold 15 with the bottom mold 16 (and example of which is described below with regard to FIGS. 8A and 8B). In the example illustrated in FIG. 5, the glass material 40 is spherical and is placed on the bottom mold 16 at the location of each cavity 55. A temperature monitoring device 65 is placed in contact with the molds 15 and 16 to monitor the temperature gradient of the glass material 40. In the example illustrated in FIG. 5, two temperature monitoring devices 65a and 65b are in contact with the top mold 15, and two temperature monitoring devices 65c and 65d are in contact with the bottom mold 16. The multiple resistive heating elements 80 allow for control of the thermal gradients across the glass material 40 during heating (and/or cooling), in some examples.

The molds 15 and 16 may each include a plurality of molds pins 17 located within a mold plate 18. FIG. 5 illustrates an example of a top mold 15 that include two mold pins 17a and 17b placed into a mold plate 18a, and a bottom mold 16 that includes two mold pins 17c and 17d placed into a mold plate 18b. The glass material 40 is spherical and is placed on the bottom mold 16 at the location of each mold pin 17c and 17d, in the example of FIG. 5. The temperature of the glass material 40 may be monitored by an infrared camera 82, which converts infrared radiation of the glass material 40 into temperature. The infrared camera 82 may be used by the controller 90 to control the temperature inside the chamber, in some examples. The infrared camera may be a Lepton camera manufactured by Flir, in some examples.

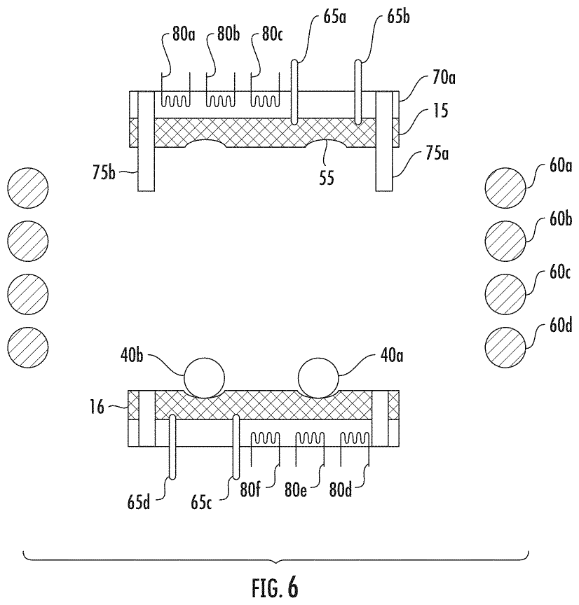

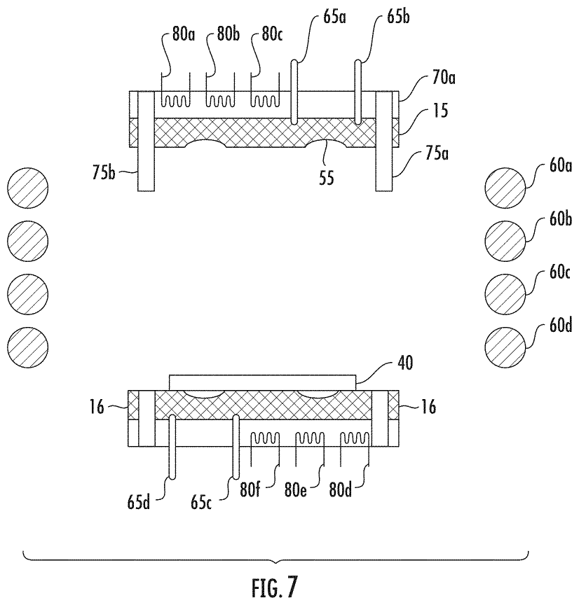

In some examples, the molds 15 and 16 may each be a singular, monolithic piece of material. FIGS. 6 and 7 illustrate examples where the molds 15 and 16 are each a singular monolithic piece of material. In the example illustrated in FIG. 6, the glass material 40 is a singular piece of glass material 40, and the molds 15 and 16 are each a singular, monolithic piece of material that includes a plurality of cavities 55 for molding a plurality of glass elements. In the example illustrated in FIG. 7, the glass material 40 is a singular, cylindrical disk of glass material 40, and the molds 15 and 16 are each a singular, monolithic piece of material that includes a plurality of cavities 55 for molding different portions of the singular, cylindrical disk of glass material 40. In both FIGS. 6 and 7, multiple resistive heating elements 80 allow for control of the thermal gradient across the glass material 40 during heating (and/or cooling), in some examples.

As is discussed above, the molding apparatus 1 may include guide pins 75 (e.g., 75a and 75b) to align the top mold 15 with the bottom mold 16. The guide pins 75 may be positioned such that the surface of the guide pins 75 are aligned with the surface of the top mold 15, and then the guide pins 75 may be actuated by a positioning device 77 (e.g., 77a and 77b) so as to extend the guide pins 75 out of the top mold 15 so they can be utilized to align holes in the top mold 15 with holes in the bottom mold 16. FIGS. 8A and 8B illustrate examples of the molds, glass elements, and alignment pins that may be utilized for this purpose. FIG. 8A illustrates the guide pins 75 retracted in a heating position such that the pins 75 do not shadow the radiant light from the lamps. Shadowing may cause thermal gradients, in some examples. The pins 75 are located within the top mold 15. The bottom mold 16 contains follower pins 79 (e.g., 79a and 79b) which serve the purpose of filling the holes in the bottom mold 16 during heating. The follower pins 79 are preloaded against the bottom mold 16 by springs 78 (e.g., 78a and 78b). FIG. 8B illustrates the guide pins 75 extended to align the top mold 15 and bottom mold 16. The positioning device 77 may be actuated during the molding process such that the controller 90 may set the retracted position (seen in FIG. 8A) during heating, and the extended position (seen in FIG. 8B) during pressing. The follower pins 79 are displaced by the guide pins 75 during pressing.

Modifications, additions, or omissions may be made to molding apparatus 1 without departing from the scope of the disclosure. Also, any suitable logic may perform (and/or control) the functions of molding apparatus 1 and the components and/or devices within molding apparatus 1. Furthermore, one or more components of molding apparatus 1 may be separated, combined, and/or eliminated.

This specification has been written with reference to various non-limiting and non-exhaustive examples. However, it will be recognized by persons having ordinary skill in the art that various substitutions, modifications, or combinations of any of the disclosed examples (or portions thereof) may be made within the scope of this specification. Thus, it is contemplated and understood that this specification supports additional examples not expressly set forth in this specification. Such examples may be obtained, for example, by combining, modifying, or reorganizing any of the disclosed steps, components, elements, features, aspects, characteristics, limitations, and the like, of the various non-limiting and non-exhaustive examples described in this specification.

1. A molding apparatus for molding one or more glass elements by heating of one or more glass materials and pressing the one or more glass materials between an upper mold and a lower mold, the molding apparatus comprising:
a radiant heating module comprising a plurality of radiant heating elements;
an upper resistive heating module comprising a first plurality of independently controlled resistive heating elements; and
a lower resistive heating module comprising a second plurality of independently controlled resistive heating elements.

2. The molding apparatus of claim 1, further comprising the upper mold and the lower mold, wherein each of the upper mold and the lower mold is a singular monolithic piece of material.

3. The molding apparatus of claim 1, further comprising the upper mold and the lower mold, wherein each of the upper mold and the lower mold comprises a plurality of mold pins arranged in a mold plate.

4. The molding apparatus of claim 1, wherein each of the upper and lower resistive heating modules are in contact with a plate having one or more channels for inert gas flow.

5. The molding apparatus of claim 1, further comprising:
the upper mold; and
a ram that displaces the upper mold relative to the lower mold, wherein the ram comprises a screw, a motor, and a bearing assembly.

6. The molding apparatus of claim 1, further comprising a sealed processing chamber for molding the one or more glass elements.

7. The molding apparatus of claim 1, wherein the one or more glass materials comprise one or more spherical glass materials.

8. The molding apparatus of claim 1, wherein the one or more glass materials comprise a singular, cylindrical disk of glass material.

9. The molding apparatus of claim 1, wherein the plurality of radiant heating elements comprise a plurality of independently controlled radiant heating elements.

10. A molding apparatus for molding precision glass elements by heating of a glass material, or materials, and pressing the glass material, or materials, between an upper mold comprising a single or plurality of molds, and a lower mold comprising a single or plurality of molds to form a glass element or elements, the upper and lower molds being aligned by guide pins, wherein said guide pins are connected to a positioning device so the surface of the guide pin is aligned with the surface of the mold and then extended out of the mold so the guide pin can be utilized to align holes in the top mold with holes in the bottom mold.

11. A molding apparatus for molding precision glass elements by heating of a glass material, or materials, in a processing chamber and pressing the glass material, or materials, between an upper mold comprising a single or plurality of molds, and a lower mold comprising a single or plurality of molds to form a glass element or elements, wherein heating is achieved by a radiant heating module mounted in the processing chamber comprising a plurality of radiant heating elements, the radiant heating module capable of mounting and un-mounting from the processing chamber whilst maintaining the plurality of radiant heating elements in the radiant heating module.
